(19) United States
(12) Patent Application Publication
(10) Pub. No.: US 2005/0288471 A1
(43) Pub. Date: Dec. 29, 2005

(54) Method for producing oligomers derived from butenes

(75) Inventors: Stefan Bitterlich, Dirmstein (DE); Hartwig Voss, Frankenthal (DE); Gunter Schuch, Ludwigshafen (DE); Thomas Heidemann, Viernheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/533,082

(22) PCT Filed: Oct. 28, 2003
(86) PCT No.: PCT/EP03/11929

§ 371 Date: Apr. 28, 2005

(30) Foreign Application Priority Data
Oct. 30, 2002 (DE) 102 50 468.7

(51) Int. Cl. C08F 10/00; C08F 110/10; C08F 210/10

(52) U.S. Cl. 526/348.7; 585/517

(57) ABSTRACT

The present invention relates to a process for preparing oligomers consisting mainly of repeating units derived from 1- or 2-butene from a hydrocarbon stream consisting substantially of branched and linear hydrocarbon compounds having 4 carbon atoms, and comprising olefinic branched and linear hydrocarbon compounds having 4 carbon atoms (C₄ starting stream) by
a. in step a), separating the C₄ starting stream into a fraction consisting mainly of linear hydrocarbon compounds having 4 carbon atoms (l-C₄ fraction) and a fraction consisting mainly of branched hydrocarbon compounds having 4 carbon atoms (b-C₄ fraction), by contacting the C₄ starting stream with a membrane which is easier to pass for linear hydrocarbon compounds having 4 carbon atoms than for branched hydrocarbon compounds having 4 carbon atoms,
b. in step b), optionally after removing butanes, oligomerizing the olefinic hydrocarbon compounds having 4 carbon atoms present in the l-C₄ fraction,
c. in step c), subjecting the olefinic hydrocarbon compounds having 4 carbon atoms present in the b-C₄ fraction to one of the following steps: c1. reaction with methanol to give methyl tert-butyl ether (step c1) c2. hydroformylation to give substantially isovaleraldehyde (step c2) c3. polymerization to polyisobutylene (step c3) c4. dimerization to 2,4,4-trimethyl-1-pentene (step c4) c5. alkylation, substantially to form saturated hydrocarbon compounds having 8 or 9 carbon atoms (step c5).

The present invention relates to a process for preparing oligomers consisting mainly of repeating units derived from 1- or 2-butene from a hydrocarbon stream consisting substantially of branched and linear hydrocarbon compounds having 4 carbon atoms, and comprising olefinic branched and linear hydrocarbon compounds having 4 carbon atoms (C₄ starting stream) by
a. in step a), separating the C₄ starting stream into a fraction consisting mainly of linear hydrocarbon compounds having 4 carbon atoms (l-C₄ fraction) and a fraction consisting mainly of branched hydrocarbon compounds having 4 carbon atoms (b-C₄ fraction), by contacting the C₄ starting stream with a membrane which is easier to pass for linear hydrocarbon compounds having 4 carbon atoms than for branched carbon compounds having 4 carbon atoms,
b. in step b), optionally after removing butanes, oligomerizing the olefinic hydrocarbon compounds having 4 carbon atoms present in the l-C₄ fraction,
c. in step c), subjecting the olefinic hydrocarbon compounds having 4 carbon atoms present in the b-C₄ fraction to one of the following steps:
   c1. reaction with methanol to give methyl tert-butyl ether (step c1)
   c2. hydroformylation to give substantially isovaleraldehyde (step c2)
   c3. polymerization to polyisobutylene (step c3)
   c4. dimerization to 2,4,4-trimethyl-1-pentene (step c4)
   c5. alkylation, substantially to form saturated hydrocarbon compounds having 8 carbon atoms (step c5).

Processes for preparing oligomers, in particular octenes and dodecenes, derived from butenes are common knowledge.

The octenes or dodecenes generally serve as starting products for the preparation of alcohols which are obtainable from the starting products by hydroformylation and subsequent hydrogenation. The alcohols frequently find use in the preparation of plasticizers or surfactant alcohols.

For the use as plasticizer alcohol, the degree of branching plays a decisive role for the properties of the plasticizer. The degree of branching is described by the iso index which expresses the average number of methyl branchings in a particular fraction. For example, n-octenes with 0, methylheptenes with 1 and dimethylhexenes with 2 contribute to the iso index of a C₈ fraction. The lower the iso index, the more linear the construction of molecules in the particular fraction. The higher the linearity, i.e. the lower the iso index, the higher the yields in the hydroformylation and the better the properties of the plasticizer produced therefrom. A low iso index, for example in the case of phthalate plasticizers, has a favorable effect with regard to low volatility and better cold crack temperature of the plasticized PVC produced with the plasticizer.

Processes for preparing unbranched octene or dodecene are disclosed, for example, by WO 9925668 and 0172670.

In order to be able to obtain the desired plasticizers with the low iso index, the starting materials required for the preparation of the octenes or dodecenes are olefinic C₄ hydrocarbon fractions which comprise a very low proportion of branched C₄ hydrocarbons.

As a consequence of the very close boiling points, the separation of branched and linear olefinic hydrocarbon compounds having 4 carbon atoms can be carried out distillatively only with difficulty. For this reason, it has been proposed to react the isobutene under conditions under which 1- and 2-butene behave substantially inertly and to remove the reaction product.

Suitable for this purpose are, for example, a) the reaction with methanol to give methyl tert-butyl ether (MTBE) or the Lewis-acid catalyzed polymerization to polyisobutylene (cf. Industrielle Organische Chemie, K. Weissermel, H.-J. Arpe, Verlag Wiley-VCH, 1998, 5th Edition, Chapter 3.3.2.)

It is also known (loc. cit.) that linear hydrocarbon compounds having 4 carbon atoms are selectively absorbed on certain molecular sieves, thus allowing separation of isobutene to be achieved.

EP-A-481660 states that membranes having a zeolite structure are suitable for the separation of n-butanes from isobutane.

It is an object of the present invention to provide a process which enables a) the preparation of substantially unbranched octene and dodecene from a fraction comprising both linear and branched olefinic hydrocarbon compounds having 4 carbon atoms and b) the simultaneous preparation of various chemical intermediates which are derived from isobutene in high yields.

We have found that this object is achieved by the invention defined at the outset.

The starting stream generally consists of
from 30 to 99%, preferably from 40 to 96%, more preferably from 50 to 70% by weight of olefinic branched and linear hydrocarbon compounds having 4 carbon atoms (C₄⁼fraction)
preferably from 5 to 55% by weight of saturated branched and linear hydrocarbons having 4 carbon atoms (C₄⁻fraction)
optionally up to 50%, preferably up to 5% by weight of other unsaturated hydrocarbon compounds having 4 carbon atoms
optionally up to 50%, preferably up to 5% by weight of hydrocarbon compounds having less than 4 or more than 4 carbon atoms.

In general, the sum of olefinic branched and linear hydrocarbon compounds having 4 carbon atoms and saturated linear and branched hydrocarbon compounds having 4 carbon atoms in the total amount of the C₄ starting stream is at least 30%, preferably 50% by weight.

The other unsaturated hydrocarbon compounds having 4 carbon atoms are generally butadienes, alkynes or allenes.

The hydrocarbon compounds having less than 4 or more than 4 carbon atoms are preferably propane, propene, pentanes, pentenes, hexanes or hexenes.

In general, the C₄ starting stream is prepared by carrying out the following sequence of steps:
removing a C₄ hydrocarbon fraction (C₄ stream) from a hydrocarbon stream from natural sources or obtainable by subjecting naphtha or other streams which comprise hydrocarbon compounds to a steam cracking or FCC process,
preparing a C₄ hydrocarbon stream (raffinate l) consisting substantially of isobutene, 1-butene, 2-butene and butanes from C₄ stream by hydrogenating the butadienes and butynes to C₄-alkenes or C₄-alkanes by means of selective hydrogenation or removing the butadienes and butynes by extractive distillation,
freeing raffinate l of catalyst poisons by treating with adsorbent materials and in this way obtaining C₄ starting stream.

If desired, the raffinate l can be used in step a) without preceding removal of catalyst poisons. In this case, the removal of the catalyst poisons is carried out immediately after step a).

C₄ stream is prepared, for example, from LPG or LNG streams. LPG means Liquefied Petroleum Gas (liquid gases). Such liquid gases are defined, for example, in DIN 51 622. They generally comprise the hydrocarbons propane, propene, butane, butenes and their mixtures, as obtained in oil refineries as by-products in distillation and cracking of crude oil and also in the benzene separation in the course of natural gas processing. LNG means Liquefied Natural Gas. Natural gas consists mainly of saturated hydrocarbons which, depending on their origin, have different compositions and are generally divided into three groups. Natural gas from pure natural gas deposits consists of methane and a little ethane. Natural gas from crude oil deposits additionally comprises relatively large amounts of higher molecular weight hydrocarbons such as ethane, propane, isobutane, butane, hexane, heptane and by-products. Natural gas from condensate and distillate deposits comprises not only methane and ethane, but also, to a considerable extent, higher-boiling components having more than 7 carbon atoms. For a more detailed description of liquid gases and natural gas, reference may be made to the appropriate keywords in Römpp, Chemielexikon, th Edition.

The LPG and LNG used as a feedstock comprises in particular field butanes, as the C₄ fraction of the “moist” fractions of natural gas and also the accompanying crude oil gases are known, which are removed from the gases in liquid form by drying and cooling to about −30° C. The field butanes, whose composition varies depending on the deposit, but which generally contain about 30% of isobutane and about 65% of n-butane, are obtained therefrom by low temperature or pressure distillation.

It is also possible to obtain the C₄ stream by subjecting naphtha or other hydrocarbon compounds to a steam cracking or FCC process and distillatively removing the C₄ stream from the hydrocarbon products formed.

In the generally known FCC process (cf. Ullmann's Encyclopedia of Industrial Chemistry, Wiley-VCH Verlag GmbH, Weinheim, Germany, Sixth Edition, 2000 Electronic Release, Chapter Oil Refining, 3.2. Catalytic Cracking), the appropriate hydrocarbon is evaporated and contacted in the gas phase with a catalyst at a temperature of from 450 to 500° C. The particulate catalyst is fluidized by the hydrocarbon stream conducted in countercurrent. The catalysts used are customarily synthetic crystalline zeolites.

In the likewise generally known steam cracking process (cf. A. Chauvel, G. Lefebvre: Petrochemical Processes, 1 Synthesis-Gas Derivatives and Major Hydrocarbons, 1989 Editions Technip 27 Rue Ginoux 75737 Paris, France, Chapter 2), the hydrocarbon is mixed with steam and, depending on the residence time, heated in tubular reactors to temperatures of from 700 to 1200° C. and afterwards cooled rapidly and distillatively separated into individual fractions.

The raffinate l can be obtained from the C₄ stream by removing or partially hydrogenating the dienes, alkynes and enynes.

Preference is given to carrying out the substep of butadiene extraction from crude C₄ cut with a butadiene-selective solvent selected from the class of polar aprotic solvents, such as acetone, furfural, acetonitrile, dimethylacetamide, dimethylformamide and N-methylpyrrolidone.

Preference is given to carrying out the substep of selective hydrogenation of butadiene and acetylenic impurities present in the C₄ stream in two stages by contacting the crude C₄ cut in the liquid phase with a catalyst which comprises at least one metal selected from the group of nickel, palladium and platinum, on a support, preferably palladium on aluminum oxide, at a temperature of from 20 to 200° C., a pressure of from 1 to 50 bar, a catalyst hourly space velocity of from 0.5 to 30 m³ of fresh feed per m³ of catalyst per hour and a ratio of recycle to feed stream of from 0 to 30 at a molar ratio of hydrogen to diolefins of from 0.5 to 50, in order to obtain a reaction effluent in which, in addition to isobutene, the n-butenes 1-butene and 2-butene are present in a molar ratio of from 2:1 to 1:10, preferably from 2:1 to 1:2, and substantially no diolefins or acetylenic compounds are present.

The raffinate l stream is generally purified over at least one guard bed consisting of high-surface-area aluminum oxides, silica gels, aluminosilicates or molecular sieves. The guard bed serves to dry the raffinate l stream and also to remove substances which can act as catalyst poison in one of the subsequent conversion steps. The preferred adsorber materials are Selex-sorb CD and CDO, and also 3 Å and NaX molecular sieves (13×). The purification is effected in drying towers at temperatures and pressures which are selected in such a way that all components are in the liquid phase.

When the catalyst poisons are removed immediately after step a), the l-C₄ and b-C₄ fractions are treated in a similar manner.

The separation in step a can be carried out by membrane processes known per se (cf. EP-A-481660). Useful membrane materials are, for example, polymers or inorganic materials having molecular sieve properties. The latter are, for example, prepared by pyrolysis of organic polymers such as polypropylene or are zeolites, for example those of the MFI type such as silicalite of the ZSM-5 type.

The membranes are preferably configured as integrally symmetrical or as composite membranes in which the actual separating layer effecting the molecular separation which has a thickness of from 0.1 to 100 μm, preferably from 1 to 20 μm, is applied to one or more meso- and/or macroporous supports.

The membranes are used in the form of flat, pillow, capillary, monochannel tubular or multichannel tubular elements, which are known per se to those skilled in the art from other membrane separating processes such as ultrafiltration or reverse osmosis. In the case of membrane elements having tubular geometry, the separating layer is preferably disposed on the inside of the tube.

The membranes are generally surrounded by one or more casings of polymeric, metallic or ceramic material, and the connection between casing and membrane is formed by a sealing polymer (for example elastomer) or inorganic material.

The membrane process is customarily operated in such a way that the C₄ starting stream in liquid or gaseous form is contacted with the membrane and the l-C₄ fraction passing the membrane is removed in gaseous form, and the pressure on the side of the membrane on which the C₄ starting stream is disposed (feed side) is greater than the pressure on the side of the l-C₄ fraction (permeate side). The temperature at which the mixture to be separated is contacted with the membrane is typically between 20 and 200° C., preferably from 50 to 150° C. The pressure on the feed side of the membrane is advantageously from 1 to 100 bar abs., preferably from 2 to 40 bar abs., and is generated by mechanical compression or pumps and heating of the feed stream to a temperature which leads to a vapor pressure of the feed mixture corresponding to the desired feed pressure. The pressure on the permeate side is from 0.1 to 50 bar, preferably from 0.5 to 10 bar, and the pressure on the feed side is always higher than that on the permeate side. The pressure on the permeate side is set by removing the permeate stream by means of a vacuum pump or of a compressor or by condensing the permeate stream at a temperature which leads to an autogenous pressure on the permeate mixture corresponding to the desired permeate pressure.

One way of performing the membrane process is in one stage, i.e. the permeate from a membrane apparatus or the combined permeates from a plurality of membrane apparatus flowed through by the feed in series and/or parallel, without further treatment, forms the linear hydrocarbon-enriched l-C₄ fraction mentioned and the nonpermeated fraction (retentate), without further treatment, forms the branched-hydrocarbon-enriched b-C₄ fraction mentioned. However, the membrane process may also be carried out in two or more stages, by conducting the permeate from one stage as the feed into the following stage in each case and mixing the retentate from this stage with the feed into the former stage. Such arrangements are known per se (see, for example, Sep.Sci.Technol. 31 (1996), 729 ff).

The separating process achieves a proportion of the l-C₄ fraction in the b-C₄ fraction and a proportion of the b-C₄ fraction in the l-C₄ fraction of from 10 ppm by weight to 30% by weight, preferably from 1000 ppm by weight to 25% by weight, more preferably from 1 to 20% by weight.

In step b, in which the oligomerization of the l-C₄ fraction is carried out, preference is given to preparing mainly octenes and dodecenes over nickel catalysts.

Octenes and dodecenes constitute valuable intermediates which can in particular be converted by hydroformylation and subsequent hydrogenation to nonanol and tridecanol respectively.

It has proven advantageous to partly distillatively remove n-butane from the l-C₄ fraction after step a. The l-C₄ fraction used in step b preferably contains not more than 30% by weight, more preferably 15% by weight, of n-butane.

Useful nickel catalysts are in particular those nickel-containing catalysts which are known to promote little oligomeric branching, cf., for example, prior art references cited in DE 4339713 and WO 01/37989, and these references in particular relating to the catalysts are explicitly incorporated herein by way of reference. Particular preference is given to catalysts which comprise both sulfur and nickel as active components.

Very particular preference is given to combining catalysts which differ in the S:Ni ratio. Advantageously, the catalyst used in the first reaction stage has an S:Ni ratio of <0.5 mol/mol, and is preferably a catalyst according to WO 01/37989 or DE 4339713, and the catalyst used in the second reaction stage has an S:Ni ratio of >0.5 mol/mol, and is preferably a catalyst according to EP 272970, U.S. Pat. No. 3,959,400, FR 2641477 or U.S. Pat. No. 4,511,750 having an S:Ni ratio of >0.8, more preferably 1.0.

The abovementioned catalysts may be used, for example, in processes as described, for example, in WO 99125668 and WO 01/72670, which are explicitly incorporated herein by way of reference.

When the nickel catalyst in the reactor is disposed in a plurality of fixed beds, the feed may be introduced into the reactor divided and at a plurality of points, for example upstream of a first fixed bed in the flow direction of the reaction mixture and/or between individual fixed Ni catalyst beds. When a reactor battery is used, it is possible, for example, to feed the feed completely to the first reactor of the battery or to feed it to the individual reactors of the battery through a plurality of feeds, as described for the case of the single reactor.

The oligomerization reaction generally takes place at temperatures of from 30 to 280, preferably from 30 to 190 and in particular from 40 to 130° C., and a pressure of generally from 1 to 300 bar, preferably from 5 to 100 bar and in particular from 10 to 50 bar. The pressure is advantageously selected in such a way that the feed is supercritical and especially liquid at the temperature set.

The reactor is generally a cylindrical reactor charged with the Ni catalyst; alternatively, a battery of a plurality, preferably two or three, such reactors connected in series can be used.

In the reactor or the individual reactors of the reactor battery, the nickel catalyst may be disposed in a single or in a plurality of fixed nickel catalyst beds. It is also possible to use different nickel catalysts in the individual reactors of the battery. It is also possible to set different reaction conditions in the individual reactors of the reactor battery with regard to pressure and/or temperature within the abovementioned pressure and temperature ranges.

The first reaction stage should be operated at >50%, preferably >70% and more preferably >90%, overall olefin conversion, while the second reaction stage should ensure the remaining conversion, so that a total overall olefin conversion of >91%, preferably >95% and more preferably >97% results. This is in principle also possible using the catalyst of the first reaction stage alone, although it would require, in comparison to the invention, either high reaction temperatures which lead to relatively rapid catalyst deactivation, or large catalyst volumes which would put into question the economic viability of the process.

Both the first and the second reaction stage may each consist of one or more reactors connected in series, as described in WO 99/25668 or 01/72670.

The isobutene-rich b-C₄ fraction is further converted by one of the 5 following processes, i.e. the entire amount of the b-C₄ fraction is further converted by only one of these processes, or proportions of this fraction can also be further converted each by different processes.

MTBE is prepared from methanol and the isobutene-rich b-C₄ fraction in step c.1 generally at from 30 to 100° C. and slightly elevated pressure in the liquid phase over acidic ion exchangers. It is customary to work either in two reactors or in a two-stage shaft reactor, in order to achieve virtually complete isobutene conversion (>99%). To prepare pure MTBE, the pressure-dependent azeotrope formation between methanol and MTBE entails multistage pressure distillation or is achieved by relatively new technology by methanol adsorption on adsorber resins. All other components of the C₄ fraction remain unchanged. Since small amounts of diolefins and acetylenes can shorten the lifetime of the ion exchanger by polymer formation, preference is given to using bifunctional PD-containing ion exchangers, in which case only diolefins and acetylenes are hydrogenated in the presence of small amounts of hydrogen. The etherification of isobutene is unaffected.

The preparation of MTBE can also be carried out in a reactive distillation (see, for example, Smith, EP 405781).

MTBE serves primarily to increase the octane number of transport gasoline. MTBE and IBTBE can alternatively be dissociated over acidic oxides in the gas phase at from 150 to 300° C. to obtain pure isobutene.

To prepare isovaleraldehyde in step c.2, the b-C₄ fraction is converted together with synthesis gas. The configuration of the process is generally known and is described, for example, in J. Falbe: New Syntheses with Carbon Monoxide, Springer Verlag, Berlin Heidelberg New York 1980, Chapter 1.3. Co-complexes in particular have proven useful as catalysts. For instance, the catalyst used in the BASF process is HCO(CO)₄ in aqueous solution and is reacted with the substrate in a loop reactor.

Polyisobutylene is prepared in step c.3 generally over acidic homogeneous and heterogeneous catalysts, for example tungsten trioxide on titanium dioxide or boron trifluoride complexes. In this way, an effluent stream can be obtained at isobutene conversions of up to 95% which has a maximum residual isobutene content of 5%.

The preparation of high molecular weight polyisobutylene having molecular weights of 100 000 and more is described, for example, in H. Guterbock: Polyisobutylen und Mischpolymerisate, p. 77 to 104, Springer Verlag, Berlin 1959.

Low molecular weight polyisobutylenes having a number-average molar mass of from 500 to 5000 and a high content of terminal vinylidene groups and their preparation are disclosed, for example, by DE-A-2702604, EP-A-628 575 and WO 96/40808.

In the alkylation of step c.5, the b-C₄ fraction is reacted with branched saturated hydrocarbons having 4 or 5 carbon atoms. This forms mainly branched saturated hydrocarbons having 8 or 9 carbon atoms which are used mainly as a fuel additive for improving the octane number. The catalysts used in the reaction are typically hydrofluoric acid or sulfuric acid.

1. A process for preparing oligomers consisting mainly of repeating units derived from 1- or 2-butene from a hydrocarbon stream consisting substantially of branched and linear hydrocarbon compounds having 4 carbon atoms, and comprising olefinic branched and linear hydrocarbon compounds having 4 carbon atoms (C₄ starting stream) by;
a. separating the C₄ starting stream into a fraction consisting mainly of linear hydrocarbon compounds having 4 carbon atoms (l-C₄ fraction) and a fraction consisting mainly of branched hydrocarbon compounds having 4 carbon atoms (b-C₄ fraction), by contacting the C₄ starting stream with a membrane which is easier to pass for linear hydrocarbon compounds having 4 carbon atoms than for branched carbon compounds having 4 carbon atoms;
b. optionally after removing butanes, oligomerizing the olefinic hydrocarbon compounds having 4 carbon atoms present in the l-C₄ fraction;
c. subjecting the olefinic hydrocarbon compounds having 4 carbon atoms present in the b-C₄ fraction to one of the following steps:
c1. reaction with methanol to give methyl tert-butyl ether;
c2. hydroformylation to give substantially isovaleraldehydel;
c3. polymerization to polyisobutylene;
c4. dimerization to 2,4,4-trimethyl-1-pentene; and
c5. alkylation, substantially to form saturated hydrocarbon compounds having 8 or 9 carbon atoms.

2. A process as claimed in claim 1, wherein the membrane used is made of inorganic material having molecular sieve properties.

3. A process as claimed in claim 1, wherein the membrane used consists at least partly of zeolites of the MFI type.

4. A process as claimed in claim 1, wherein the separation in step a) is carried out in such a way that the C₄ starting stream in liquid or gaseous form is contacted with the membrane and the l-C₄ fraction passing the membrane is removed in gaseous form, and the pressure on the side of the membrane on which the C₄ starting stream is disposed is greater than the pressure on the side of the l-C₄ fraction.

5. A process as claimed in claim 1, wherein the C₄ starting stream used consists substantially of;
from 30 to 99% by weight of olefinic branched and linear hydrocarbon compounds having 4 carbon atoms;
optionally from 1 to 70% by weight of saturated branched and linear hydrocarbon compounds having 4 carbon atoms; and
optionally up to 50% by weight of any other unsaturated hydrocarbon compounds having 4 carbon atoms; and
optionally from 0 to 50% by weight of any hydrocarbon compounds having less than 4 or more than 4 carbon atoms.

6. A process as claimed in claim 5, wherein the C₄ starting stream is prepared by carrying out the following sequence of steps:
removing a C₄ hydrocarbon fraction (C₄ stream) from a hydrocarbon stream from natural sources or obtainable by subjecting naphtha or other mixtures which consist essentially of hydrocarbons to a steam cracking or FCC process;
preparing a C₄ hydrocarbon stream consisting substantially of isobutene, 1-butene, 2-butene and butanes (raffinate l) from C₄ stream by hydrogenating the butadienes and butynes to C₄-alkenes or C₄-alkanes by means of selective hydrogenation or removing the butadienes and butynes by extractive distillation; and
freeing raffinate l of catalyst poisons by treating with adsorbent materials and in this way obtaining C₄ starting stream.

7. A process as claimed in claim 1 any of claims 1, wherein, in step b, the l-C₄ fraction is converted mainly to octenes and dodecenes over a nickel catalyst.

8. A process as claimed in claim 1, wherein, in step b, the removal of butanes is effected distillatively.

9. A process as claimed in claim 7, wherein the octenes or dodecenes are converted to nonanol or tridecanol by hydroformylation and subsequent hydrogenation.
